(19) United States
(12) Patent Application Publication
(10) Pub. No.: US 2004/0243652 A1
(43) Pub. Date: Dec. 2, 2004

(54) Backup system and backup method

(75) Inventor: Toshio Furuta, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/854,305

(22) Filed: May 27, 2004

(30) Foreign Application Priority Data
May 27, 2003 (JP) 2003-148766

(51) Int. Cl. G06F 17/30

(52) U.S. Cl. 707/204

(57) ABSTRACT

A server updates data in a first database according to a request from a terminal and sends updated data in the first database to a network by an e-mail. A relay apparatus receives data from the network and forwards only an e-mail to a second database. A second server updates data in the second database according to an e-mail received from the relay apparatus.

### BACKGROUND OF THE INVENTION

1. Field of the Invention

The present invention relates to a backup system, and particularly relates to a backup system that backs up via a network.

2. Description of Related Art

To back up data, there is a technique that uses a storage medium for backup (hereinafter called a save disk). In this backup technique, the data of a storage medium normally used is periodically saved to a save disk. There is also technique that a plurality of save disks are prepared and backup data for a few counts is saved. For example, suppose that seven save disks are prepared and backup is performed once a day. If data is saved in a different save disk every data, backup data for seven days can be saved. However, when a plurality of save disks are provided, the configuration cost of a server increases.

There is also technique that a mirror server is provided in place of a save disk and data is saved in the mirror server. In this case, backup is performed in the mirror server from a server normally used via a network.

Various backup systems that backup is performed via a network are disclosed (see Japanese Patent laid-open No 2002-358245 and Japanese Patent laid-open No 2002-312213, for example). Particularly, in Japanese Patent laid-open No 2002-312213, it is described that data is enciphered and transferred.

For an example of a system required to back up data, sales force automation (SFA) is conceivable. SFA is a system for supporting the activity of a sales staff. FIG. 7 shows the concept of SFA. An SFA server 101 is connected to terminals 111 to 113 via the Internet 50. The terminals 111 to 113 are used by a sales staff, his/her chief, a customer and others. Each terminal 111 to 113 may be also a mobile terminal. In FIG. 7, three terminals are shown, however, in addition, a terminal used by an executive of the company is also connected to SFA 101 via the Internet 50.

The SFA server 101 is provided with a database 102. Each terminal 111 to 113 transmits an e-mail to the SFA server 101 and transmits data to the SFA server 101 using a browser. The SFA server 101 stores received data in the database 102. For example, the SFA server 101 receives customer information, product information, stock information, price reduction information, sales activity information and others and stores them in the database 102. The sales activity information is information showing concrete activity such as when, to whom and what is sold and when, from whom and what is ordered.

Besides, the SFA server 101 transmits information stored in the database 102 to each terminal according to a request from each terminal 111 to 113. Each terminal 111 to 113 displays information received from the SFA server 101 by the browser. The SFA server 101 may graph a situation of orders and process information based on the sales activity information and may transmit the data of the graph to each terminal 111 to 113.

As described above, the SFA server 101 can store data received from each terminal and can transmit the data to another terminal. As a result, the sales staff can read and refer to cases of success and failure of past sales activity. Besides, the sales staff can read the instruction and the opinion of his/her chief outside the company such as at a customer via the SFA server 101. Besides, the sales staff can report a situation of his/her activity via an e-mail and others from the outside of the company. The chief of the sales staff can transmit his/her direction and opinion to the sales staff outside of the company. The chief can also read sales activity and graphed data. The executive of the company can also read sales activity information. Therefore, they can visit a customer after they grasp trouble. The customer can also read the outline of an estimate via the SFA server 101.

When the SFA server 101 backs up data stored in the database 102, for example, the SFA server 101 itself may be provided with a save disk and backs up data using the save disk. Or a mirror server may be provided separately from the SFA server 101 and data may be also stored in the mirror server.

The conventional backup system, however, has the following problems. Some persons unfairly invade an information processing unit such as a server and falsify, destroy or erase data. Suppose that data in a normally used database is falsified. When the data is backed up, a save disk or a mirror server stores the falsified data. When data is falsified, it often takes long time for a network manager to notice the occurrence of falsification and others. Therefore, even if the network manager tries to recover data, backup data is also falsified and work for recovery requires enormous labor.

Particularly, the data of a server accessed via the Internet, such as the data of the SFA server is easily falsified, broken or erased. Therefore, a problem that the result of falsification and others has an effect upon backup data is easily caused.

Even if data is ciphered and transferred in backup as in a method described in the above Japanese Patent laid-open No 2002-312213, transferred data itself may be falsified and such a problem cannot be solved.

### SUMMARY OF THE INVENTION

An object of the invention is to provide a backup system and a backup method that can prevent data stored as backup data from being falsified even if a server normally used is invaded and data is in danger of being falsified, broken or erased.

Embodiments within the scope of the present invention may achieve one or more of the above objectives, in whole or in part.

According to one aspect of the present invention, a backup system is provided which comprises: a first element that updates data in a first storage according to a request from at least one terminal and that sends updated data in the first storage to a network by an e-mail; a second element that receives data from the network and that forwards only an e-mail to a second storage; and a third element that updates data in the second storage according to an e-mail received from the second element.

According to another aspect of the present invention, a backup method comprising: updating data in a first storage according to a request from a terminal; sending updated data in the-first storage to a network by an e-mail; receiving data from the network; forwarding only an e-mail to a second storage; and updating data in the second storage according to an received e-mail.

### BRIEF DESCRIPTION OF THE DRAWINGS

For a better understanding of the invention as well as other objects and features thereof, reference is made to the following detailed description to be read in conjunction with the accompanying drawings, wherein:

FIG. 1 is a block diagram showing a configuration according to one embodiment of the present invention;

FIG. 2 is a block diagram showing a configuration of an information server;

FIG. 3 is a block diagram showing a configuration of a backup server;

FIG. 4 is a flowchart showing a process according to the embodiment of FIG. 1;

FIG. 5 is a block diagram showing a configuration according to the embodiment of FIG. 1 when a second network is an intranet.

FIG. 6 is a block diagram showing a configuration according to another embodiment of the present invention; and

FIG. 7 shows a block diagram outlining a configuration of SFA.

### DETAILED DESCRIPTION OF THE PREFERRED EMBODIMENTS

In the following, embodiments of the present invention will be described with reference to the drawings.

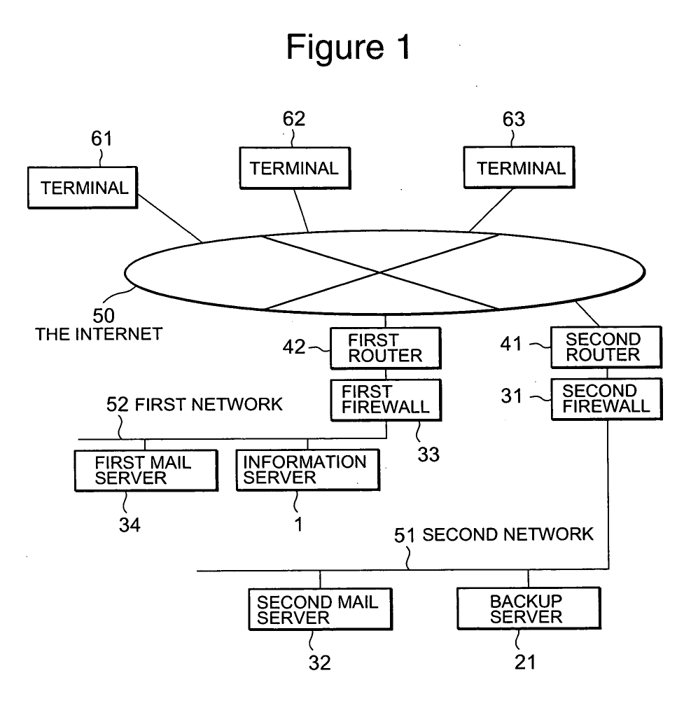

Referring to FIG. 1, a backup system according to one embodiment comprises a backup server 21, a first firewall 33, a first mail server 34, an information server 1, a second firewall 31 and a second mail server 32. The backup server 21 and the second mail server 32 may be also integrated as one server, however, a case that the second mail server 32 is provided separately from the backup server 21 will be described below. Similarly, the information server 1 and the first mail server 34 may be also integrated as one server, however, case that the first mail server 34 is provided separately from the information server 1 will be described below.

The backup server 21, the second firewall 31 and the second mail server 32 are connected via a second network 51. The second network 51 is connected to the Internet 50 via a second router 41.

The information server 1, the first firewall 33 and the first mail server 34 are connected via a first network 52. The first network 52 is connected to the Internet 50 via a first router 42.

Terminals 61 to 63 are connected to the Internet 50. In FIG. 1, the three terminals are shown, however, the number of terminals is not limited to three. The information server 1 is a server that provides service to the terminals 61 to 63 via the Internet 50. The contents of the service are not limited. A case that the information server 1 functions as an SFA server and provides sales activity support service will be described below. The information server 1 is provided with a database as described later and updates data in the database according to a request from each terminal 61 to 63. For a type of data updating, there are the addition of new data, the alteration of stored data and the deletion of data. The information server 1 transmits the contents of update to the backup server 21 by an e-mail when data in the database is updated.

The first firewall 33 permits only data that fulfills a predetermined condition out of data transmitted/received by communication between the side of the Internet 50 and the side of the first network 52 to go through and blocks other data. As a result, unfair invasion into the information server is prevented. The first firewall 33 permits data to which at least an e-mail port or an http port is, added out of data transmitted/received by communication started from the side of the Internet. 50 to go through. The first firewall 33 also permits data to which at least an e-mail port is added out of data transmitted/received by communication started from the side of the first network 52 to go through. At least an e-mail can be transmitted/received between the Internet 50 and the first network 52 by making data pass as described above, and data can be transmitted/.received between each terminal 61 to 63 connected to the Internet 50 and the information server 1 by Hypertext Transfer Protocol (HTTP)

The port means a code showing what communication program transfers transmitted/received data and is defined in Transmission Control Protocol (TCP). Ane-mail port is added to data transmitted as an e-mail and an http port is added to data transmitted/received by http. The e-mail port means Simple Mail Transfer Protocol (SMTP) port. The addition of the port to data means that the port number is inserted into a header of a packet in which transmitted/received data is stored.

A series of data transmitted/received after the start of communication is also included in “the data transmitted/received by communication started from the side of a certain network”. Suppose that communication is started between the terminal 61 (on the side of the Internet 50) and the information server 1 (on the side of the first network 52) according to a request from the terminal 61. In this case, data which the information server 1 transmits to the terminal 61 according to the request from the terminal 61 is also included in “the data transmitted/received by communication started from the side of the Internet 50”.

In the following description, for example, a case that the first firewall 33 permits only data to which an e-mail port or an http port is added out of data transmitted/received by communication started from the side of the Internet 50 to go through and permits only data to which an e-mail port is added out of data transmitted/received by communication started from the side of the first network 52 to go through will be described.

The first mail server 34 receives an e-mail from the information server 1 and transmits the e-mail to another mail server. The first mail server 34 also receives an e-mail from another mail server and transmits the e-mail addressed to the information server 1 to the information server 1.

The backup server 21 is a server for backing up data stored in the information server 1. That is, the backup server receives data from the information server 1 and stores the same data as the data stored in the information server 1 as backup data. The, backup server 21 receives data showing the updated contents of data in the information server 1 from the information server 1 by an e-mail and updates data.

The second firewall 31 permits only data that fulfills a predetermined condition out of data transmitted/received by communication between the side of the Internet 50 and the side of the second network 51 to go through and blocks other data. As a result, unfair invasion into the backup server 21 is prevented. The second firewall 31 permits only data to which an e-mail port is added out of data transmitted/received by communication started from the side of the Internet 50 to go through. The backup server 21 only receives an e-mail out of communication started from the side of the Internet 50 and can block other communication. As described later, for communication started from the side of the second network 51, the second firewall 31 may pass data except an e-mail. However, in this embodiment, a case that the second firewall 31 blocks all communication started from the side of the second network 51 will be described.

The second mail server 32 receives an e-mail addressed to the backup server 21 from the first mail server 34 and transmits the e-mail to the backup server 21.

Each terminal 61 to 63 is a terminal used by a person related to sales activity (a sales staff, his/her chief or a customer) The terminals 61 to 63 mount browser and mailer (e-mail software), display a Web page and transmit/receive an e-mail. The terminals 61 to 63 transmit an e-mail according to SMTP. The terminals 61 to 63 may be also a mobile terminal.

When a user of each terminal 61 to 63 operates to instruct the update of the data of the information server 1, each terminal 61 to 63 transmits a command requiring the update of the data (hereinafter called an update command) and updated contents to the information server 1. For example, suppose that each terminal 61 to 63 receives a Web page from the information server 1 and displays it. In case data (data A) to be added to the database is input and operation to transmit the data A is executed on the Web page, the terminals 61 to 63 transmit an update command requiring the addition of data and updated contents to which the data A is added to the information server 1. In case operation to change certain data B stored in the database to data C is executed, the terminals 61 to 63 transmit an update command requiring the change of data and updated contents including the data C in place of the data B to the information server 1. Similarly, in case operation to delete data D in the database is executed, the terminals 61 to 63 transmit an update command requiring the deletion of data and updated contents in which the data D is deleted to the information server 1.

The terminals 61 to 63 add an http port and transmit data when an update command and updated contents are transmitted according to the operation on the Web page. The information server 1 adds an http port and transmits data when data on the Web page is transmitted according to the request of the terminals 61 to 63.

The terminals 61 to 63 transmit a command requiring the transmission of data (hereinafter called a data requiring command) to the information server 1 when operation to read the data is executed. The terminals receive the data from the information server 1 and display it.

When the terminals 61 to 63 transmit an e-mail to the information server 1, they transmit the e-mail to a mail server (the mail server is not shown) and the mail server transmits the e-mail to the first mail server 34. The information server 1 receives the e-mail from the first mail server 34. At this time, the transmission/reception of the e-mail from the terminal to the first mail server 34 is executed according to SMTP. Therefore, the terminals 61 to 63 add an e-mail port to the data of the transmitted e-mail and transmit data. As already described above, the information server 1 and the first mail server 34 may be also integrated as one server.

When the information server 1 transmits an e-mail to the backup server 21, the information server 1 transmits the e-mail to the first mail server 34 and the first mail server 34 transmits the e-mail to the second mail server 32. The backup server 21 receives the e-mail from the second mail server 32. At this time, the transmission/reception of the e-mail from the information server 1 to the second mail server 32 is executed according to SMTP. Therefore, the information server 1 adds an e-mail port to the data of the transmitted e-mail and transmits data. As already described above, the backup server 21 and the second mail server may be also integrated as one server.

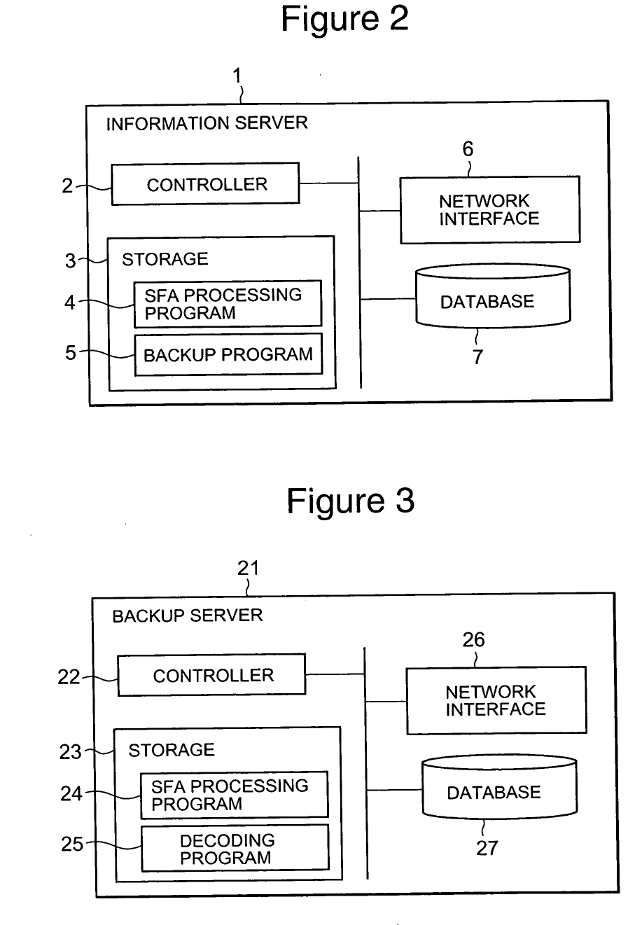

FIG. 2 is a block diagram showing a configuration of the information server 1 according to the embodiment of FIG. 1. A controller 2 executes processing according to a program stored in a storage 3. The storage 3 stores an SFA processing program 4 and a backup program 5. A network interface 6 transmits/receives data via the second network 52.

A database 7 is a storage for storing various data related to sales activity. The database 7 stores data transmitted from the terminals 61 to 63 and data registered by a network manager beforehand.

For example, the database 7 stores product information, catalog data, estimate information, trouble information and price reduction ratio information. The database 7 also stores customer information, the information of a person in charge of a customer, business talk information, sales activity information and the comment of a chief on a person in charge of sales. Further, the database 7 stores the screen information of various Web pages (for example, a public Web page for a customer and a profitable Web page for a special user).

The controller 2 executes the following processing according to the SFA processing program 4. That is, the controller 2 updates data stored in the database 7 according to an update command and updated contents when the update command and the updated contents are received from the terminals 61 to 63. For example, when an update command requiring the addition of data is received, the controller 2 adds new data to the database 7 according to updated contents. When an update command requiring the change of data is received, the controller 2 changes the data of the database 7 according to updated contents. When an update command requiring the deletion of data is received, the controller 2 deletes data from the database 7 according to updated contents.

The controller 2 transmits required data (for example, various information such as product information) to the terminals 61 to 63 when the controller 2 receives a data requiring command from the terminals 61 to 63. The controller 2 transmits a Web page displaying the required data to the terminal. The controller 2 takes the statistics of data stored in the database 7, creates a graph showing the change of data respectively according to the data requiring command and may also transmit a Web page showing the result to the terminals 61 to 63. For example, the controller 2 creases a statistical graph showing the sales of various products and a graph showing the transition of sales and may also transmit a Web page displaying the graph to the terminals 61 to 63.

The controller 2 may also execute an electronic forum control process according to the SFA processing program 4. For a type of the electronic forum, there are mailing list and an electronic bulletin board, however, the embodiment is not limited to a specific type. The controller 2 may also make data written by an e-mail stored in the database 7. In this case, the reception itself of the e-mail means the occurrence of an update command. That is, the controller 2 recognizes that an update command is input when an e-mail is incoming. The controller 2 stores the contents of the e-mail in the database 7.

The controller 2 executes the following processing according to the backup program 5. The controllers 2 enciphers an update command and updated contents received together with the update command when the reception of the update command is detected. The controller executes processing for transmitting the enciphered data to the backup server 21 by an e-mail.

FIG. 3 is a block diagram showing a configuration of the backup server 21 according to the embodiment of FIG. 1. A controller 22 executes processing according to a program stored in a storage 23. The storage 23 stores an SFA processing program 24 and a decoding program 25. A network interface 26 transmits/receives data via the second network 51. A database (A backup database) 27 is a storage for storing the same data as data stored in the database 7 of the information server 1. Data stored in the database 27 is backup data.

The controller 22 executes the following processing according to the decoding program 25. The controller 22 decodes data when receiving the data from the information server 1 by an e-mail.

The controller 22 executes the following processing according to the SFA processing program 24. The controller 22 updates data stored in the database 27 according to an update command and updated contents respectively acquired by decoding. Processing for updating the database 27 according to the update command and the updated contents by the controller 22 is similar to the processing for updating the database 7 by the controller 2 of the information server 1.

The backup server 21 never transmits data according to a request from the terminals 61 to 63. Therefore, the SFA processing program 24 of the backup server 21 may include no instruction to make the controller 22 create a graph and to transmit data to the terminal.

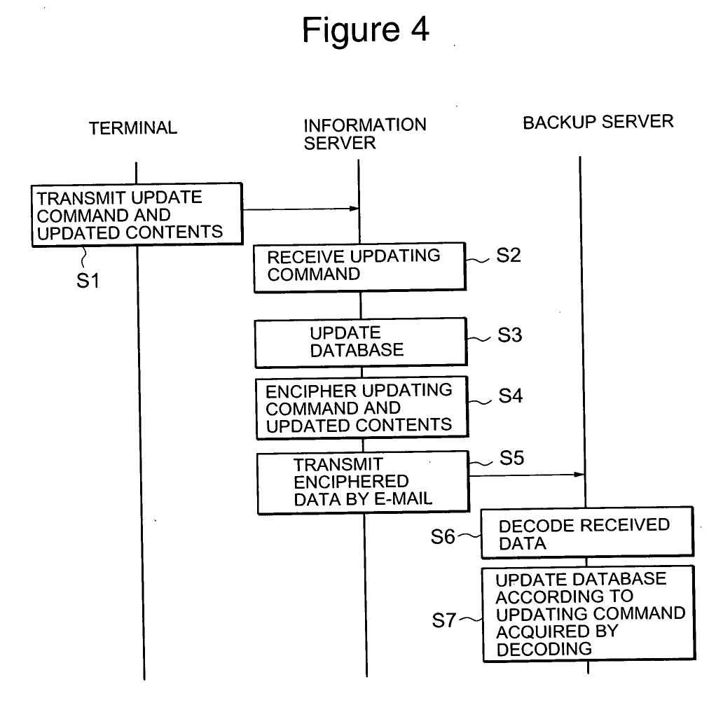

The flow of processing until the backup server 21 updates the data of the database 27 will be described. FIG. 4 is a flowchart showing an example of a process since the terminal transmits an update command until the backup server 21 updates the database 27.

The terminal (the terminal 61 in this case) receives a Web page from the information server 1 and displays it. At this time, it is preferable that the information server 1 authenticates a user of the terminal 61 using ID and a password. The terminal 61 transmits an update command and updated contents to the information server 1 when operation to update data is executed on the Web page (step S1).

The first firewall 33 permits data to which an http port is added out of data transmitted/received by communication started from the side of the Internet 50 to go through. Therefore, the terminal 61 can receive a Web page from the information server 1 and can display it. When the terminal 61 transmits an update command and updated contents, the terminal 61 adds an http port to them. Therefore, the update command and the updated contents are transmitted to the information server 1 without being blocked by the first firewall 33.

When the controller 2 of the information server 1 receives an update command from the terminal 61 (step S2), the controller 2 updates data in the database 7 according to the update command and updated contents (step S3). The controller 2 enciphers the update command and the updated contents (step S4) and transmits the enciphered data to the backup server 21 by an e-mail (step S5). The controller 2 transmits the e-mail to which the enciphered data is attached. At this time, the controller 2 adds an e-mail port to data to be transmitted as an e-mail and transmits the data.

In step S5, the controller 2 of the information server 1 transmits an e-mail addressed to the backup server 21 to the first mail server 34. The first mail server 34 transmits the e-mail to the second mail server 32. At this time, the first firewall 33 permits data to which an e-mail port is added out of data transmitted/received by communication started from the side of the first network 52 to go through. The second firewall 31 permits data to which an e-mail port is added out of data transmitted/received by communication started from the side of the Internet 50 to go through. Therefore, thee-mail is transmitted to the second mail server 32 without being blocked halfway. The second mail server 32 transmits the e-mail to the backup server 21.

The controller 22 of the backup server 21 decodes the enciphered data received from the information server 1 by thee-mail (step S6). The controller 22 updates the data of the database 27 of the backup server 21 according to the update command and the updated contents respectively acquired by decoding (step S7) As a result, data stored in the database 27 is kept so that the data is the same as the data updated in step S3 of the database 7 of the information server 1.

There is also a case that the information server 1 receives an e-mail from the terminal 61 and the contents of the e-mail are added to the database 7 as written data. The terminal 61 adds an e-mail port to data to be transmitted as an e-mail. Therefore, the e-mail transmitted by the terminal 61 is not blocked by the first firewall 33. The controller 2 of the information server 1 adds the contents of the e-mail to the database 7 (step S3) when receiving the e-mail transmitted from the terminal 61 (step S2) The controller 2 enciphers the contents of the e-mail and an update command for instructing the addition of the contents (step S4) and transmits them to the backup server 21 by an e-mail (step S5) The controller 22 of the backup server 21 decodes data received by the e-mail (step S6) and adds the data to the database 27 based on the decoded update command and data (step S7).

The terminals 61 to 63 used by normal users (a person in charge of sales and others) transmit an update command and instruct the information server 1 to update data. The falsification, the destruction or the erase of data by unfair invasion utilizing a security hole is often performed without an update command. It is only in case an update command is detected that the information server 1 transmits data (enciphered data) to the backup server 21. Therefore, even if falsification and others are performed without an update command, a falsified state has no effect upon the backup server 21.

The second firewall 31 permits only data to which an e-mail port is added out of data transmitted/received by communication started from the side of the Internet 50 to go through and blocks other all data. Therefore, it is difficult to invade the backup server 21 and the security of the database 27 of the backup server 21 can be kept.

As the backup server 21 is hardly invaded as described above and the effect of the falsification and others of data in the information server 1 is prevented, the data of the database 27 is kept in an unchanged state. Therefore, even if failure occurs in the information server 1, a network manager can easily recover the information server 1 using the database 27 of the backup server 21.

In this embodiment, the information server 1 and the backup server 21 may be also provided with the respective databases 7, 27 as an external storage. A database server is connected to the first network 52 and the controller 2 of the information server 1 may also update data in the database server in step S3. Similarly, a database server is connected to the second network 51 and the controller 22 of the backup server 21 may also update data in the database server in step S7.

The controller 2 of the information server 1 may also transmit an update command and updated contents to the backup server 21 without enciphering them. However, as data to be secretly held may be included in data to be backed up, it is preferable that the data is enciphered and transmitted.

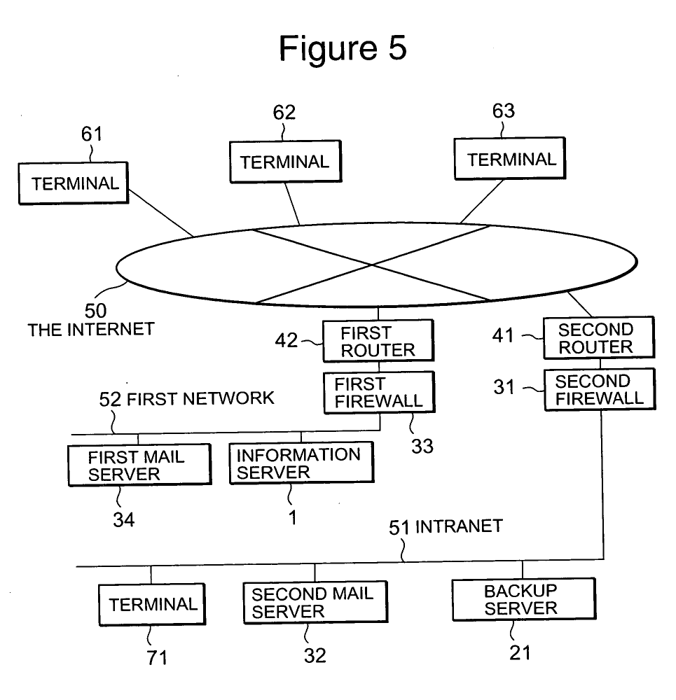

The second firewall 31 may also permit data except an e-mail to go through for communication started from the side of the second network 51. The example will be described below. FIG. 5 shows an example of configuration when the second network 5l is an intranet. The operation of the backup server 21, the second mail server 32, the information server 1, the first mail server 34 and the first firewall 33 is similar to the operation already described. A terminal 71 used by-a sales staff is connected to the intranet 51. As data stored in the backup server 21 is data for backup, a user of the terminal 71 updates the data of the database 7 of the information server 1 when he/she tries to update data.

In this case, the second firewall 31 permits only data to which an e-mail port is added out of data transmitted/received by communication started from the side of the Internet 50 to go through and permits data to which at least an e-mail port or an http port is added out of data transmitted/received by communication started from the side of the intranet 51 to go through.

In this case, for data transmitted/received by communication started from the side of the intranet 51, the second firewall 31 permits only data to which an e-mail port or an http port is added to go through. Therefore, the terminal 71 can transmit an update command and updated contents to the information server 1. The terminal 71 can also transmit an e-mail to the information server

Note that the second firewall 31 also permits only data to which an e-mail port is added out of data transmitted/received by communication started from the side of the Internet 50 to go through and blocks other data. Therefore, it is difficult to invade the backup server 21 via the Internet 50 and the security of the database 27 of the backup server 21 is kept.

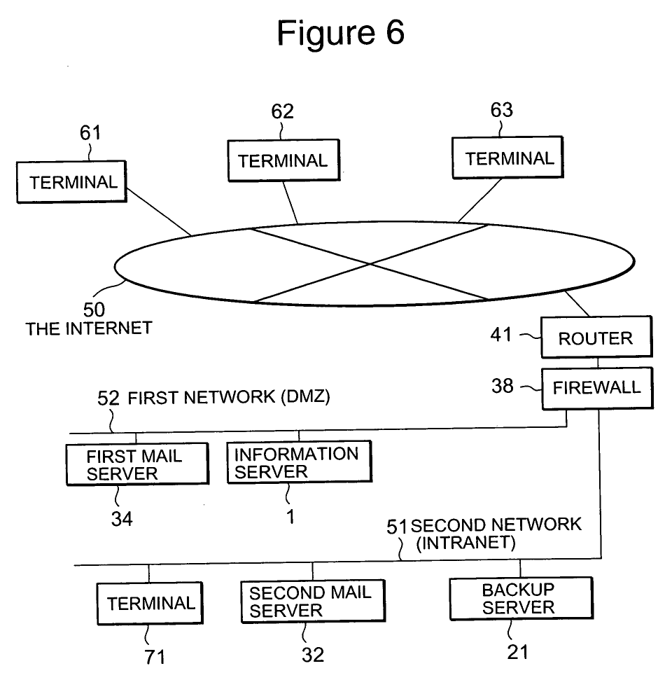

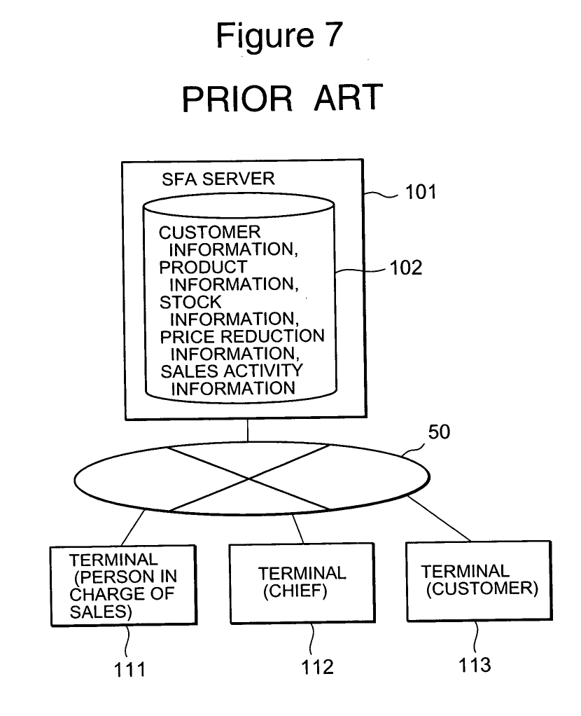

FIG. 6 is a block diagram showing a configuration according to another embodiment of the present invention. A backup system in this embodiment is provided with a backup server 21, a first mail server 34, an information server 1, a second mail server 32 and a firewall 38. As the operation of the backup server 21, the second mail server 32, the information server 1 and the first mail server 34 is similar to the operation in the embodiment of FIG. 1, the same reference number is allocated and the description is omitted. Each configuration of the information server 1 and the backup server 21 is similar to each configuration shown in FIGS. 2 and 3. The same reference number as that shown in FIGS. 2 and 3 is allocated to each element of the information server 1 and the backup server 21.

The backup server 21 and the second mail server 32 are connected via a second network 51. A case that the second network 51 is an intranet will be described as an example below. The firewall 38 is also connected to the intranet 55. A terminal 71 may be also connected to the intranet 55. The terminal 71 is a terminal similar to the terminal 71 shown in FIG. 5 in the embodiment.

The information server 1 and the first mail server 34 are connected via a first network 52. The firewall 38 is also connected to the first network 52.

The firewall 38 is connected to the Internet 50 via a router 41. Terminals 61 to 63 are connected to the Internet 50. The terminals 61 to 63 are the similar terminals to the terminals 61 to 63 described in the embodiment of FIG. 1.

The firewall 38 permits only data that fulfills a predetermined condition out of data transmitted from the side of the Internet 50, the side of the intranet 55 and the side of the first network 52 to go through and blocks other data. As a result, unfair invasion into the information server 1 and the backup server 21 is prevented. The firewall 38 complies with an application gateway system. That is application software is loaded into the firewall 38 every communication protocol and the firewall 38 relays data according to application software according to a communication protocol.

The firewall 38 relays only data transmitted/received to/from the second mail server 32 by SMTP communication in communication to the side of the intranet 55 started from the side of the first network 52 and blocks other data. The firewall 38 blocks all data in communication to the side of the intranet 55, started from the side of the Internet 50. Only the transmission of an e-mail from the first network 52 to the intranet 55 is enabled by relaying data and invasion from the Internet 50 to the intranet 55 can be prevented.

The firewall 38 relays at least data transmitted/received in SMTP communication to the first mail server 34 and http communication to the information server 1 in communication to the side of the first network 52 started from the side of the Internet 50. By relaying data as described above, an e-mail can be transmitted from the side of the Internet 50 to the information server 1-and the terminals 61 to 63 and the information server 1 can transmit/receive data by http communication. In the following description, a case that the firewall 38 relays only data transmitted/received by SMTP communication to the first mail server 34 and http communication to the information server 1 in communication to the side of the first network 52 started from the side of the Internet 50 will be described.

The firewall 38 relays at least data transmitted/received by SMTP communication to the first mail server 34 and http communication to the information server 1 in communication to the side of the first network 52 started from the side of the intranet 55. By relaying data as described above, an e-mail can be transmitted from the side of the intranet 55 to the information server 1 and the terminal 71 connected to the intranet 55 and the information server 1 can transmit/receive data by http communication. In the following description, a case that the firewall 38 relays only, data transmitted/received by SMTP communication to the first mail server 34 and http communication to the information server 1 in-communication to the side of the first network 52 started from the side of the intranet 55 will be described.

SMTP communication is communication according to SMTP and http communication is communication according to http. A series of data transmission/reception after communication is started is also included in “communication to another network started from the side of one network”. For example, suppose that communication is started between the terminal 61 (on the side of the Internet 50) and the information server 1 (on the side of the first network 52) according to a request from the terminal 61. In this case, transmission from the information server 1 to the terminal 61 according to a request of the terminal 61 is also included in “communication to the side of the first network 52 started from the side of the Internet 50”.

The firewall 38 determines a communication protocol based on a port number added to a header of a packet storing data for example.

The firewall 38 admits SMTP communication and http communication to the side of the first network 52 in communication started from the side of the Internet 50, however, the firewall 38 prohibits communication to the side of the intranet 55. The firewall admits SMTP communication to the side of the intranet 55 started from the first network 52. Therefore, in this system, the first network 52 functions as a demilitarized zone (DMZ).

The terminals 61 to 63 transmit/receive data to/from the information server 1 according to http. In case the terminals 61 to 63 transmit an e-mail to the information server 1, the terminals 61 to 63 transmit the e-mail to a mail server (not shown) and the mail server transmits the e-mail to the first mail server 34. The information server 1 receives the e-mail to the first mail server 34. At this time, the e-mail is transmitted from the terminals 61 to 63 to the first mail server 34 according to SMTP.

When the information server 1 transmits an e-mail to the backup server 21, the information server 1 transmits the e-mail to the first mail server 34 and the first mail server 34 transmits the e-mail to the second mail server 32. The backup server 21 receives the e-mail from the second mail server 32. At this time, the e-mail is transmitted from the information server 1 to the second mail server 32 according to SMTP.

Referring to FIG. 4, the flow of processing until the backup server 21 updates the data of the database 27 will be described. A terminal (in this case, the terminal 61) receives a Web page from the information server 1 and displays it. At this time, it is preferable that the information server 1 authenticates a user of the terminal 61 using ID and a password. The terminal 61 transmits an update command and updated contents to the information server 1 when operation to update data is executed on the Web page (step S1).

The firewall 38 relays data transmitted/received by http communication in communication to the information server 1 started from the side of the Internet 50. Therefore, the terminal 61 can receive a Web page from the information server 1 by http communication and can display it. When the terminal 61 transmits an update command and updated contents, the terminal 61 transmits the update command and updated contents according to http. The firewall 38 relays the update command and the updated contents to the information server 1.

When the controller 2 of the information server 1 receives an update command from the terminal 61 (step S2), the controller updates the data of the database 7 according to the update command and the updated contents (step S3). Besides, the controller 2 enciphers the update command and the updated contents (step S4) and transmits the enciphered data to the backup server 21 by an e-mail (step S5). The controller 2 transmits an e-mail to which the enciphered data is attached. At this time, the controller 2 transmits the e-mail according to SMTP.

In step S5, the controller 2 of the information server 1 transmits the e-mail addressed to the backup server 21 to the first mail server 34. The first mail server 34 transmits the e-mail to the second mail server 32 according to SMTP. The firewall 38 relays data transmitted/received by SMTP communication in communication to the second mail server 32 started from the side of the second network 51. Therefore, the e-mail is transmitted to the second mail server 32 without being blocked halfway. The second mail server 32 transmits the e-mail to the backup server 21.

The controller 22 of the backup server 21 decodes the enciphered data received from the information server 1 by the e-mail (step S6). The controller 22 updates the data of the database 27 of the backup server 21 according to the update command and the updated contents respectively acquired by decoding (step S7). As a result, data stored in the database 27 is kept the same as the data updated in the step S3 of the database 7 of the information server 1.

The information server 1 receives an e-mail from the terminal 61 and may record the contents of the e-mail into the database 7. The terminal 61 transmits an e-mail to a mail server (not shown) on the side of the Internet 50. The mail server transmits the e-mail to the first mail server 34 according to SMTP. The firewall 38 relays data transmitted/received by SMTP communication in communication to the first mail server 34 started from the side of the Internet 50. Therefore, the e-mail transmitted by the terminal 61 is not blocked by the firewall 38. The controller 2 of the information server 1 adds the contents of the e-mail to the database 7 (step S3) when the controller 2 receives the e-mail transmitted from the terminal (step S2). The controller 2 enciphers the contents of the e-mail and an update command for instructing the addition of the contents (step S4) and transmits them to the backup server 21 by an e-mail (step S5). The controller 22 of the backup server 21 decodes the data received by the e-mail (step S6) and adds the data to the database 27 based on the decoded update command and data (step S7).

Not only the terminals 61 to 63 but the terminal 71 connected to the intranet 55 may transmit an operation command and updated contents to the information server 1. The terminal 71 receives a Web page from the information server 1 and displays it as the terminals 61 to 63. When operation to update data is executed on the Web page, the terminal 71 transmits an update command and updated contents to the information server 1. The firewall 38 relays data transmitted/received by http in communication to the information server 1 started from the side of the intranet 55. Therefore, the terminal 71 can receive a Web page from the information server 1 by http communication and can display it. The terminal 71 transmits the update command and the updated contents according to http. Therefore, the firewall 38 relays the update command and the updated contents to the information server 1.

The terminal 71 may also transmit contents to be added to the database of the information server 1 by an e-mail. The terminal 71 transmits an e-mail to the second mail server 32. The second mail server 32 transmits the e-mail received from the terminal 71 to the first mail server 34 according to SMTP. The firewall 38 relays data transmitted/received by SMTP in communication to the first mail server 34 started from the side of the intranet 55. Therefore, the e-mail transmitted from the terminal 61 is not blocked by the firewall 38. The information server 1 receives the e-mail from the first mail server 34.

The operation after receiving the update command transmitted from the terminal 71 is similar to the operation in the steps S2 to S7.

As in the embodiment of FIG. 1, it is only in case the information server 1 detects an update command that the information server 1 transmits enciphered data to the backup server 21. Therefore, even if falsification and others are made without an update command, a falsified state and other states have no effect upon the backup server 21.

The firewall 38 blocks all data in communication to the side of the intranet 55 started from the side of the Internet 50. Therefore, it is difficult to invade the backup server 21 from the side of the Internet 50 and the security of the database 27 of the backup server 21 can be kept.

In another embodiment, the controller 2 of the information server 1 may also transmit an update command and updated contents to the backup server 21 without being enciphered, however, it is preferable that they are enciphered and transmitted.

As in the embodiment of FIG. 1, the backup server 21 and the second mail server 32 may be also integrated as one server. The information server 1 and the first mail server 34 may be also integrated as one server.

As in the embodiment of FIG. 1, the information server 1 and the backup server 21 may be also provided with the databases 7, 27 as an external storage. A database server may be also connected to the first network 52 and the controller 2 of the information server 1 may also update data in the database server in step S3. Similarly, a database server may be also connected to the second network 51 and the controller 22 of the backup server 21 may also update data in the database server in step S7.

The case that the information server 1 is an SFA server is described the above embodiments, however, the information server 1 is not limited to an SFA server. Therefore, data stored in the databases 7, 27 is also not limited to information related to sales such as customer information. However, it is preferable that the embodiments are applied to a system in which the frequency of the occurrence of an update command is low. “Lowness in the frequency of the occurrence of an update command” means that an interval at which a transmit command occurs is longer than time required for updating the database 7 by the controller 2 of the information server 1 (step S3), enciphering data (step S4) and transmitting data (step S5).

For a system to which the embodiments are applied except the SFA server, the following system is given as an example. For example, there is a reservation system of a hospital. In this case, the controller 2 of the information server 1 accepts the reservation of the hospital via a Web page from the terminals 61 to 63 of patients. Referring to FIG. 4, the terminals 61 to 63 transmit an update command for registering reservation time in a database and the reservation time to the information server 1 (step S1). When the controller 2 of the information server 1 receives the update command (step S2), the controller stores the data of the reservation time in the database 7 (step S3). Besides, the controller 2 enciphers the update command and the reservation time (step S4) and transmits them to the backup server 21 by an e-mail (step S5). The controller 22 of the backup server 21 decodes received data (step S6) and registers the data of reservation time in the database 27 based on the decoded data.

Similarly, the backup system according to the embodiments can be also applied to a reservation system of public facilities (for example, a public tennis court).

Besides, the embodiments can be also applied to a sales management system for ordering and receiving orders between companies. In this case, the information server 1 receives information such as the amount of orders and a due date from the terminals 61 to 63 used by a person who receives an order and a person who orders and registers the data in the database 7. Operation since each terminal 61 to 63 transmits data such as the amount of orders until the backup data 21 stores backup data is similar to the operation in the steps Step 1 to Step 7.

It is conceivable that in SFA, various reservation systems and the sales management system respectively described above, an update command occurs approximately a few times per one hour to approximately a few times per one minute. Therefore, it is considered impossible that while the processing in steps S2 to S5 is executed, the next update command is received and a load of the controller 2 is increased.

Although the invention has been described in connection with preferred embodiments thereof, it is to be understood that those embodiments are set forth solely to aid in understanding the invention, and should not be read in a sense to limit the scope of the invention. Modifications of the techniques described herein will be apparent to the skilled artisan when practicing the invention, and such modifications are to be construed as falling within the scope of the appended claims.

What is claimed is:

1. A backup system comprising:
a first element that updates data in a first storage according to a request from at least one terminal and that sends updated data in the first storage to a network by an e-mail;
a second element that receives data from the network and that forwards only an e-mail to a second storage; and
a third element that updates data in the second storage according to an e-mail received from the second element.

2. A backup system comprising:
a first server that updates data in a first database according to a request from at least one terminal and that sends updated data in the first database to a network by an e-mail;
a relay apparatus that receives data from the network and that forwards only an e-mail to a second database; and
a second server that updates data in the second database according to an e-mail received from the relay apparatus.

3. A backup system comprising:
a database for storing data;
a server that updates data stored in the database according to a request from at least one terminal connected to the Internet;
a backup database for storing the same data as data stored in the database;
a backup server that is connected to a network connected to the Internet and that updates data stored in the backup database based on data received from the server; and
a firewall that permits data fulfilling a predetermined condition out of data transmitted/received by communication
between the Internet and the network to go through, wherein, the server transmits data showing updated contents to the backup server by an e-mail when the update of data stored in the database is required from the terminal, and
the firewall permits only data to which an e-mail port is added out of data transmitted/received by communication started from the Internet to go through.

4. A backup system as claimed in claim 3,
wherein said firewall permits data to which at least one of an e-mail port and an http port is added out of data transmitted/received by communication started from said network to go through.

5. A backup system as claimed in claim 3,
wherein said server enciphers data showing the updated contents of data stored in the database and transmits the enciphered data to said backup server by an e-mail.

6. A backup system as claimed in claim 3,
wherein said network is an intranet.

7. A backup system comprising:
a database for storing data;
a server that is connected to a first network connected to the Internet and that updates data stored in the database according to a request from at least one terminal connected to the Internet;
a backup database for storing the same data as data stored in the database;
a backup server that is connected to a second network connected to the Internet and that updates data stored in the backup database based on data received from the server;
a first firewall that permits data fulfilling a predetermined condition out of data transmitted/received by communication between the Internet and said first network to go through; and
a second firewall that permits data fulfilling a predetermined condition out of data transmitted/received by communication between the Internet and the second network to go through, wherein,
the server transmits data showing updated contents to the backup server by an e-mail when the update of data stored in the database is required from the terminal, and
the second firewall permits only data to which an e-mail port is added out of data transmitted/received by communication started from the Internet to go through.

8. A backup system as claimed in claim 7,
wherein said first firewall permits data to which at least one of an e-mail port and an http port is added out of data transmitted/received by communication from the Internet to go through and permits data to which an e-mail port is added out of data transmitted/received by communication started from said first network to go through.

9. A backup method comprising:
updating data in a first storage according to a request from at least one terminal;
sending updated data in the first storage to a network by an e-mail;
receiving data from the network;
forwarding only an e-mail to a second storage; and
updating data in the second storage according to an received e-mail.

10. A computer-readable storage medium recording thereon a computer program to be executed by a backup system, comprising:
means for updating data in a first database according to a request from a terminal;
means for sending updated data in the first database to a network by an e-mail;
means for receiving data from the network;
means for forwarding only an e-mail to a second database; and
means for updating data in a second database according to an received e-mail.
